(19) United States
(12) Patent Application Publication
(10) Pub. No.: US 2012/0321930 A1
(43) Pub. Date: Dec. 20, 2012

(54) ELECTRODE ASSEMBLY AND SECONDARY BATTERY USING THE SAME

(75) Inventor: Chang-Bum Ahn, Yongin-si (KR)

(73) Assignee: Samsung SDI Co., Ltd., Yongin-si (KR)

(21) Appl. No.: 13/466,814

(22) Filed: May 8, 2012

(30) Foreign Application Priority Data
Jun. 16, 2011 (KR) 10-2011-0058509

(51) Int. Cl. H01M 4/485; H01M 2/02; H01M 2/16

(52) U.S. Cl. 429/144; 429/246; 429/231.1; 429/163

(57) ABSTRACT

There are provided an electrode assembly and a secondary battery using the same, in which a stack-type secondary battery includes an edge portion of at least one of the electrode plates to be adhered to a corresponding edge portion of the separator, so that it is possible to inhibit contraction of the separator. An electrode assembly comprises a first electrode plate; a second electrode plate; and a separator interposed between the first and second electrode plates. In the electrode assembly, the first and second electrode plates and the separator are stacked such that an edge portion of at least one of the first and second electrode plates is adhered to an edge portion of the separator.

### RELATED APPLICATIONS

This application claims priority to and the benefit of Korean Patent Application No. 10-2011-0058509, filed on Jun. 16, 2011, in the Korean Intellectual Property Office, the entire content of which is incorporated herein by reference.

### BACKGROUND

1. Field

Aspects of the present invention relate to an electrode assembly and a secondary battery using the same, and more particularly, to an electrode assembly and a secondary battery using the same capable of improving productivity.

2. Description of the Related Technology

In general, electrode assemblies used in secondary batteries may be manufactured in various shapes.

First, a wound-type electrode assembly is typically formed by winding positive and negative electrode plates to which positive and negative electrode tabs are fixed, respectively, and interposing a separator between the electrode plates. In winding of the electrode assembly, a winding core is typically disposed at a portion at which the winding of the electrode assembly is started, and the electrode assembly is wound. Then, if the winding of the electrode assembly is completed, the winding core is removed to the outside of the electrode assembly. However, the manufacturing process of the electrode assembly is very complicated.

A stack-type electrode assembly is formed by repeatedly stacking positive and negative electrode plates to which positive and negative electrode tabs are fixed, respectively, and separators interposed between the respective electrode plates. However, if the separator contracts, the positive and negative electrode plates may become misaligned and the safety of the electrode assembly may be compromised.

### SUMMARY

Embodiments provide an electrode assembly and a secondary battery using the same, in which the stack-type secondary battery is manufactured by allowing an edge portion of at least one of electrode plates to be adhered to a corresponding edge portion of a separator, so that it is possible to inhibit the contraction of the separator.

According to an aspect of the present invention, there is provided an electrode assembly including: a first electrode plate; a second electrode plate; and a separator interposed between the first and second electrode plates, wherein the first and second electrode plates and the separator are stacked such that an edge portion of at least one of the first and second electrode plates is adhered to an edge portion of the separator.

According to an embodiment, the edge portion may be continuously adhered.

According to an embodiment, the edge portion may be about 0.5 mm to about 3.0 mm.

According to an embodiment, the edge portion may be adhered using heat fusion or adhesives.

According to an embodiment, lithium tinanate (LTO) may be used as the active material of an electrode plate with a negative polarity in the first and second electrode plates.

According to an embodiment, the first and second electrode plates may have the same size.

According to an embodiment, the first electrode plate, the second electrode plate and the separator may have the same size.

According to an embodiment, the separator may have a thickness of about 30 μm to 100 about μm.

According to an embodiment, the separator may comprise an olefin-based resin.

According to an embodiment, the separator may comprise polyethylene or polypropylene.

According to an aspect of the present invention, there is provided a secondary battery including: the electrode assembly; and an outer casing that accommodates the electrode assembly.

According to embodiments of the present invention, it is possible to inhibit the ion extraction from electrode plates, due to a problem of safety and alignment caused by the contraction of a separator like. Further, it is possible to improve productivity.

### BRIEF DESCRIPTION OF THE DRAWINGS

The accompanying drawings, together with the specification, illustrate certain embodiments of the present invention, and together with the description, serve to explain the principles of embodiments of the present invention.

FIG. 1 is an exploded perspective view showing an electrode assembly according to an embodiment of the present invention.

FIG. 2 is a plan view showing an edge portion at which a first electrode plate and a separator are adhered to each other according to another embodiment of the present invention.

FIG. 3 is an assembled perspective view showing an electrode assembly according to another embodiment of the present invention.

FIG. 4 is a perspective view showing a secondary battery according to another embodiment of the present invention.

FIG. 5 is an exploded perspective view showing an electrode assembly according to another embodiment of the present invention.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements. In the drawings, the thickness or size of layers are exaggerated for clarity and not necessarily drawn to scale.

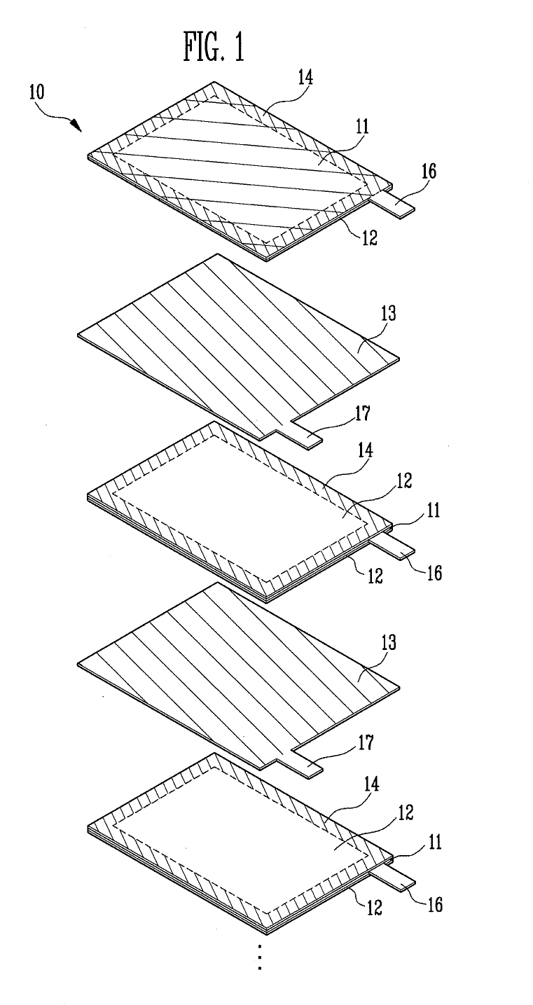

FIG. 1 is an exploded perspective view showing an electrode assembly according to an embodiment of the present invention.

Referring to FIG. 1, the electrode assembly 10 according to this embodiment is formed by stacking at least one first electrode plate 11, at least one second electrode plate 13 and at least one separator 12 interposed between the first and second electrode plates 11 and 13. In this embodiment, a first electrode tab 16 protrudes from one side of the first electrode plate 11, and a second electrode tab 17 protrudes from another side of the second electrode plate 13 generally opposite the side from which the tab 16 protrudes, i.e., so as not to be overlapped with the first electrode tab 16.

Hereinafter, for convenience of illustration, the first and second electrode tabs 16 will be referred to as positive and negative electrode tabs, respectively. In addition, the first and second electrode plates 11 and 12 will be referred to as positive and negative electrode plates, respectively.

The electrode assembly 10 according to this embodiment is a stack-type electrode assembly. As described above, the stack-type electrode assembly may be formed by sequentially stacking the at least one positive electrode plate 11, the at least one separator 12 and the at least one negative electrode plate 13. In the stack-type electrode assembly 10, it is generally not easy to align the positive and negative electrode plates 11 and 13. In the implementation of a battery, the positive and negative electrode plates 11 and 13 may come in contact with each other when the separator 12 contracts. Therefore, a short circuit may occur.

In order to solve such a problem, the separators 12 may be stacked such that they are adhered to the positive electrode plate 11. That is, a first negative electrode plate 13 may be positioned over a first positive electrode plate 11 with a separator 12 adhered to both surfaces thereof, and a second positive electrode plate 11 with separators 12 adhered to both surfaces thereof may again be positioned over the first negative electrode 13. Then, a second negative electrode plate 13 may be positioned over the second positive electrode plate 11, and still a third positive electrode plate 11 having a separator 12 adhered to a bottom surface thereof may again be positioned over the second negative electrode plate 11. Accordingly, the electrode assembly 10 can have a structure in which the positive electrode plates 11, the separators 12 and the negative electrode plates 13 are sequentially stacked.

In this embodiment, the sizes of the positive and negative electrode plates 11 and 13 may be formed to be identical to each other. The size of the separator 12 may be formed larger than that of each of the positive and negative electrode plates 11 and 13. An edge portion 14 of the positive electrode plate 11 and a region in which the separator 12 corresponding to the edge portion 14 is adhered to the positive electrode plate 11 may be continuously formed. The edge portion 14 may be formed by allowing the separator 12 and the first electrode plate 11 to be adhered using heat fusion or an adhesive.

In a case where the adhesion region is formed on the entire surface of the separator 12 and the positive electrode plate 11, the resistance of the battery is increased, and therefore, the power characteristics of the battery may deteriorate. The positive or negative electrode plate 11 or 13 fused in the fusion of the entire surface may damage the porosity of the separator 12. Generally, pores of 38 to 53% are formed in the separator 12. However, if the positive or negative electrode plate 11 or 13 is fused to the separator 12 such that an adhesive layer (binder-based monomer) is not present on the separator 12, the pores of the separator 12 may be blocked, causing contraction. Therefore, it may be difficult to implement the battery in certain applications. The temperature of the heat fusion may be at least 100° C. or higher. The porosity of the separator 12 may be decreased to 10% or less at the temperature described above, and therefore, it may be difficult to implement performance of the battery. If the adhesion region is discontinuously formed at a portion of the circumference of the separator 12 and the positive electrode plate 11, the positive and negative electrode plates 11 and 13 can come into contact with each other while a portion of the separator 12 is contracted. Therefore, a short circuit may occur.

In the manufacture of a stack-type secondary battery, the edge portion 14 of the positive electrode plate 11 may be adhered to one region of the separator 12 corresponding to the edge portion 14. The positive and negative electrode plates 11 and 13 may then be stacked, so that it is possible to prevent the contraction of the separator 12. Accordingly, it is possible to improve the safety of the secondary battery and to facilitate the alignment of the positive electrode plate 11, the negative electrode plate 13 and the separator 12.

In FIG. 1, the number of the positive electrode plates 11, the separators 12 and the negative electrode plates 13 is not limited and may be variously modified so as to implement the stack-type secondary battery.

Hereinafter, the positive electrode plate 11, the negative electrode plate 13 and the separator 12 according to embodiments of the present invention will be briefly described.

The positive electrode plate 11 may include a positive electrode collector having excellent conductivity and a positive electrode active material layer coated on at least one surface of the positive electrode collector. In this instance, the positive electrode tab 16 having a positive electrode active material not coated thereon is formed to protrude from one side of the positive electrode plate 11. Aluminum (Al), which has excellent conductivity, may be used as the positive electrode collector. The positive electrode active material layer 11 a may be formed by coating a positive slurry on at least one surface of the positive electrode collector. In the positive slurry, a positive electrode active material, a conducting agent and a positive electrode binder may be mixed together.

Here, the positive electrode active material may generate electrons by participating in a positive electrode chemical reaction of a lithium secondary battery, and the conducting agent may transfer the electrons generated in the positive electrode active material to the positive electrode collector. The positive electrode binder can bind the positive electrode active material and the conducting agent to each other so as to maintain the mechanical strength of the positive electrode plate 11.

Although lithium complex metal oxides such as LiCoO₂, LiMn₂O₄, LiNiO₂, LiNi-xCoxO₂ (0<x>1), LiMnO₂ and lithium tinanate (LTO) may be used as the positive electrode active material, embodiments of the present invention are not limited thereto.

The negative electrode plate 13 may include a negative electrode collector made of a conductive metal sheet and a negative electrode active material layer coated on at least one surface of the negative electrode collector. In this instance, the negative electrode tab 17 having a negative electrode active material not coated thereon may be formed to protrude from one side of the negative electrode plate 13. The negative electrode active material layer may include a negative electrode active material and a negative electrode binder that binds the negative electrode active material to the negative electrode collector.

Here, the negative electrode collector may be formed of copper (Cu) or nickel (Ni). The LTO may be used as the negative electrode active material. The LTO identical to the positive electrode active material may be used as the negative electrode active material, and the positive and negative electrode plates 11 and 13 may be formed to have the same size. Li₄Ti₅O₁₂ or the like may be used as the LTO.

The separator 12 may be interposed between the positive and negative electrode plates 11 and 13, and an insulating thin film having high ion transmittance and mechanical strength may be used as the separator 12. The separator 12 can prevent an electrical short circuit between positive and negative electrodes in the charging or discharging of a battery, and enable only the movement of lithium ions.

The separator 12 may be formed of a micro-porous material in which the movement of lithium ions is possible. The separator 12 may be formed of an olefin-based resin or equivalent thereof For example, the separator 12 may be formed of polyethylene (PE) or polypropylene (PP).

The separator 12 may be formed to have a thickness of about 30 μm to about 100 μm. If the separator 12 is formed to have a thickness of below about 30 μm, micro cracks or pores may be formed in the separator 12 when the separator 12 is thermally fused to the positive electrode plate 11. If the separator 12 is formed to have a thickness of over about 100 μm, the resistance of the separator 12 may increase, and the flow of current interrupted.

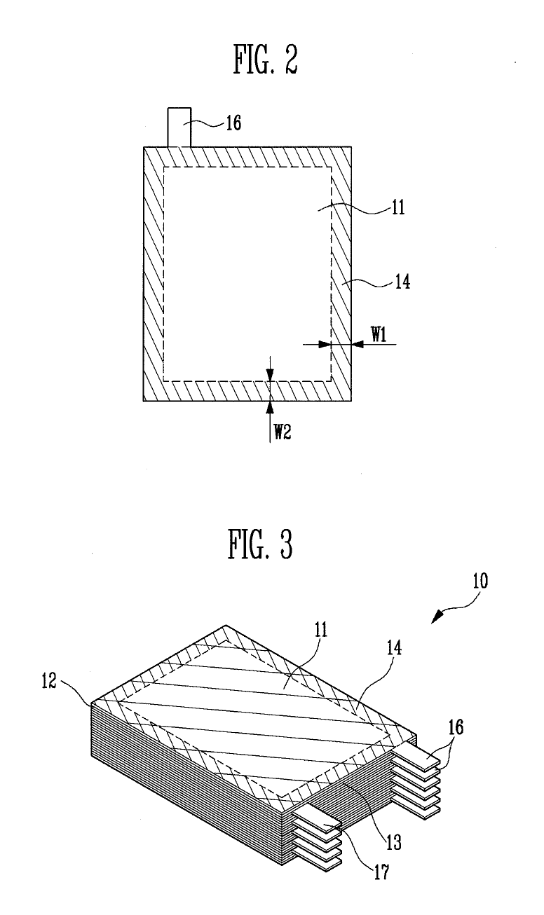

FIG. 2 is a plan view showing an edge portion at which the first electrode plate and the separator are adhered to each other according to another embodiment of the present invention.

FIG. 2 shows an embodiment in which the separator 12 (see FIG. 1) is adhered to the bottom surface of the positive electrode plate 11. The positive electrode plate 11 and the separator 12 may be formed to have the same size, except that the positive electrode tab 16 may be formed to protrude from the positive electrode plate 11. In this embodiment, the negative electrode plate 13 may also be formed to have the same size as the positive electrode plate 11 and the separator 12. A portion of the separator 12 having a predetermined width may be adhered to a portion of the edge portion 14 of the positive electrode plate 11 having a predetermined width. W1 and W2 represent widths of the edge portions 14 adhered to the separator 12. The widths W1 and W2 may be the same. According to an embodiment, widths W1 and W2 are continuously formed to be about 0.5 mm by about 3.0 mm along the edge portion 14.

If the width of the adhered edge portion 14 is formed to be below about 0.5 mm, misalignment of the separator, the positive electrode plate or the negative electrode plate from the stacked assembly may occur due to weakening or deterioration of adhesion. If the width of the adhered edge portion exceeds about 3.0 mm, the capacity of the battery may decrease. Thus, the width W1 or W2 of the adhered edge portion 14 is preferably formed to be about 5.0 mm to about 3.0 mm.

FIG. 3 is an assembled perspective view showing an electrode assembly according to another embodiment of the present invention.

Referring to FIG. 3, the electrode assembly 10 may be formed by alternately stacking a plurality of positive electrode plates 11, a plurality of negative electrode plates 13, and separators interposed between the positive and negative electrode plates 11 and 13. In the illustrated embodiment, positive and negative electrode active materials are coated on the positive and negative electrode plates 11 and 13, respectively. Positive electrode tabs 16 may be formed to protrude from one side of the positive electrode plates 11, respectively. Negative electrode tabs may be formed to protrude in the same direction as the positive electrode tabs 16, and from a side of the negative electrode plates 13 opposing the side from which the positive electrode tabs protrude.

According to an embodiment of a stack-type battery configured as described above, the separator 12 and an edge portion 14 of the positive electrode plate 11 are adhered to each other so that it is possible to inhibit contraction of the separator 12. That is, the separator 12 can be fixed to the positive electrode plate 11 by continuous adhesion along the separator 12 and the edge portion 14 of the positive electrode plate 11. Accordingly, it is possible to inhibit the separator 12 from contracting. Since the step of aligning the positive electrode plate 11 and the separator 12 is not necessary, operation time can be reduced, and thus productivity can be improved.

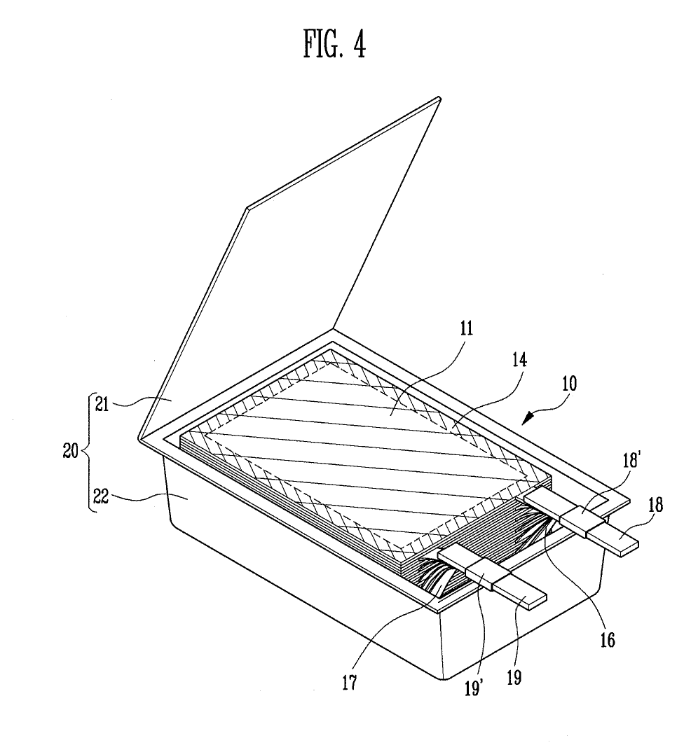

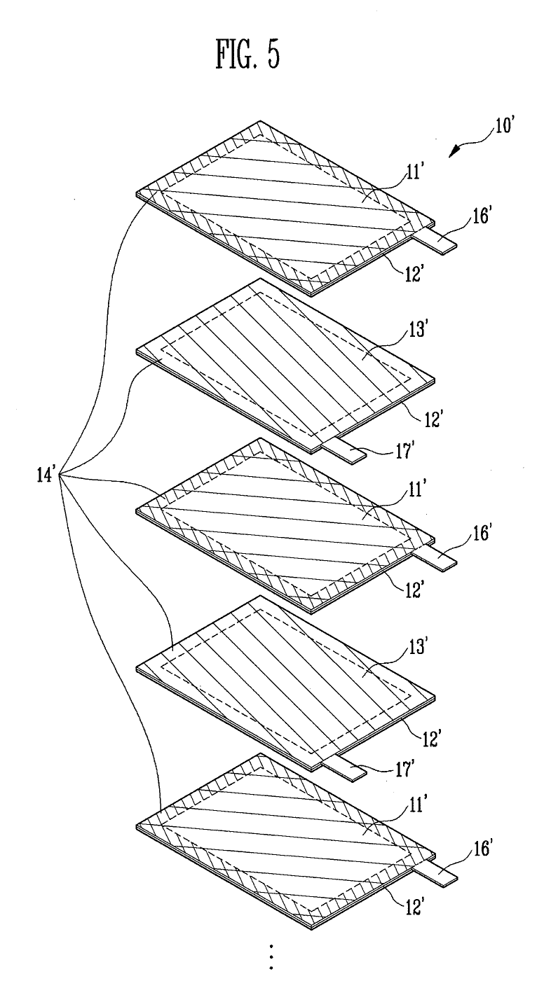

FIG. 4 is a perspective view showing a secondary battery according to another embodiment of the present invention.

Referring to FIG. 4, the electrode assembly 10 is accommodated inside an outer casing 20. The outer casing 20 may be a pouch case composed of an accommodating portion 22 and a cover portion 21 that seals the accommodating portion 22.

The pouch case 20 may be formed to have a stacked structure in which top and bottom surfaces of an aluminum thin film are covered by a synthetic resin such as nylon, polypropylene or polyethylene. The inner surface of the pouch case 20 may be made of a heat adhesive resin. Thus, the heat adhesive resin coated on the inner surface of the pouch case 20 may be mutually fused by the application of heat and pressure, so that the pouch case 20 can be sealed.

When the electrode assembly 10 is accommodated in the accommodating portion 22 of the pouch case 20, a positive electrode lead tab 18 bonded to the positive electrode tab 16 and a negative electrode lead tab 19 bonded to the negative electrode tab 17 may be partially exposed to the exterior of the pouch case 20, respectively. In this instance, insulating tapes 18′ and 19′ are adhered to the respective positive and negative electrode lead tabs 18 and 19 that come in contact with the pouch case 20. Here, the insulating tapes 18′ and 19′ may increase the sealing between the pouch case 20 and the positive and negative electrode lead tabs 18 and 19 and ensure the state of electrical insulation.

FIG. 5 is an exploded perspective view showing an electrode assembly according to another embodiment of the present invention. In FIG. 5, descriptions of components identical to those of the embodiment shown in FIG. 1 will not be provided.

As shown in FIG. 5, the electrode assembly 10′ according to this embodiment is formed by stacking positive electrode plates 11′, separators 12′ and negative electrode plates 13′ such that the separators 12′ are alternately adhered to edge portions 14′ of the positive and negative electrode plates 11′ and 13′.

That is, a first negative electrode plate 13′ having a separator 12′ adhered to a bottom surface thereof is positioned over a first positive electrode plate 11′ having a separator 12′ adhered to a bottom surface thereof A second positive electrode plate 11′ having a separator 12′ adhered to a bottom surface thereof is positioned over the first negative electrode plate 13′. Then, a second negative electrode plate 13′ having a separator 12′ adhered to a bottom surface thereof is positioned over the second positive electrode plate 11′, and still a third positive electrode plate 11′ having a separator adhered to a bottom surface thereof is again positioned over the second negative electrode plate 13′. Accordingly, the electrode assembly 10′ can have a structure in which the positive electrode plates 11′, the separators 12′ and the negative electrode plates 13′ are sequentially stacked.

In this embodiment, the positive electrode plate 11′, the negative electrode plate 13′ and the separator 12′ are formed to have the same size. Thus, the separator 12′ and the positive electrode plate 11′ may be adhered to each other along the edge portion 14′ of the positive electrode plate 11′ by, for example, heat fusion or adhesives, and the separator 12′ and the negative electrode plate 13′ may be adhered to each other along the edge portion 14′ of the negative electrode plate 13′ by, for example, heat fusion or adhesives.

As described above, the edge portion 14′ may be adhered to the separator 12′, so that it is possible to facilitate the alignment of the positive electrode 11′, the separator 12′ and the negative electrode plate 13′ and to inhibit contraction of the separator 12′.

While the present invention has been described in connection with certain embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode assembly comprising:
a first electrode plate;
a second electrode plate; and
a separator interposed between the first and second electrode plates,
wherein the first and second electrode plates and the separator are stacked such that an edge portion of at least one of the first and second electrode plates is adhered to an edge portion of the separator.

2. The electrode assembly according to claim 1, wherein the edge portion is continuously adhered throughout its width and length.

3. The electrode assembly according to claim 1, wherein the edge portion is 0.5 mm by 3.0 mm.

4. The electrode assembly according to claim 1, wherein the edge portion is adhered by heat fusion or an adhesive.

5. The electrode assembly according to claim 1, wherein one of the first and second electrode plates is a negative electrode plate, and the negative electrode plate comprises an active material comprising lithium tinanate (LTO).

6. The electrode assembly according to claim 1, wherein the first and second electrode plates have the same size.

7. The electrode assembly according to claim 6, wherein the first electrode, the second electrode and the separator have the same size.

8. The electrode assembly according to claim 1, wherein the separator has a thickness ranging from about 30 μm to about 100 μm.

9. The electrode assembly according to claim 1, wherein the separator comprises an olefin-based resin.

10. The electrode assembly according to claim 9, wherein the separator comprises polyethylene or polypropylene.

11. The electrode assembly according to claim 1, wherein the edge portion of the first electrode plate is adhered to the edge portion of the separator.

12. The electrode assembly according to claim 11, wherein the edge portion of the first electrode plate is adhered to the edge portion of the separator at two opposing surfaces of the first electrode plate.

13. The electrode assembly according to claim 12, wherein the first electrode plate is a positive electrode plate.

14. The electrode assembly according to claim 1, wherein the separator comprises a first separator and a second separator, wherein the edge portion of the first electrode plate is adhered to an edge portion of the first separator, and wherein the edge portion of the second electrode plate is adhered to an edge portion of the second separator.

15. A secondary battery comprising:
the electrode assembly according to claim 1; and
an outer casing that accommodates the electrode assembly.

16. The secondary battery according to claim 15, wherein the edge portion of the first electrode plate is adhered to the edge portion of the separator.

17. The secondary battery according to claim 16, wherein the edge portion of the first electrode plate is adhered to the edge portion of the separator at two opposing surfaces of the first electrode plate.

18. The secondary battery according to claim 15, wherein the separator comprises a first separator and a second separator, wherein the edge portion of the first electrode plate is adhered to an edge portion of the first separator, and wherein the edge portion of the second electrode plate is adhered to an edge portion of the second separator.

19. An electrode assembly comprising:
a first electrode plate;
a second electrode plate; and
a first separator interposed between the first and second electrode plates,
wherein a portion of the first electrode plate is adhered to a portion of the first separator to thereby inhibit short circuits between the first and second electrode plates.

20. The electrode assembly according to claim 19, further comprising a second separator, wherein a portion of the second electrode plate is adhered to a portion of the second separator.
